(19) United States
(12) Patent Application Publication
(10) Pub. No.: US 2025/0056452 A1
(43) Pub. Date: Feb. 13, 2025

(54) METHOD AND APPARATUS FOR PERFORMING HANDOVER

(71) Applicant: ELECTRONICS AND TELECOMMUNICATIONS RESEARCH INSTITUTE, Daejeon (KR)

(72) Inventors: Yong Sun KIM, Daejeon (KR); Kapseok CHANG, Daejeon (KR); Young Jo KO, Daejeon (KR)

(73) Assignee: ELECTRONICS AND TELECOMMUNICATIONS RESEARCH INSTITUTE, Daejeon (KR)

(21) Appl. No.: 18/799,944

(22) Filed: Aug. 9, 2024

(30) Foreign Application Priority Data
Aug. 11, 2023 (KR) 10-2023-0105706

(51) Int. Cl. H04W 56/00; H04W 74/0833

(52) U.S. Cl. CPC H04W 56/002; H04W 74/0833

(57) ABSTRACT

A method of a terminal may comprise: receiving, from a first transmission and reception point (TRP) connected to the terminal, a message indicating terminal-based timing advance (TA) acquisition; receiving synchronization signal block(s) (SSB(s)) from one or more TRPs belonging to neighboring cell(s) according to the indication of the first TRP; determining a timing advance (TA) based on the SSB(s); transmitting information on the TA to the first TRP; receiving a cell switch command from the first TRP; and establishing a connection with a second TRP selected according to the cell switch command among the one or more TRPs belonging to the neighboring cell(s).

### CROSS-REFERENCE TO RELATED APPLICATIONS

This application claims priority to Korean Patent Application No. 10-2023-0105706 filed on Aug. 11, 2023 with the Korean Intellectual Property Office (KIPO), the entire contents of which are hereby incorporated by reference.

### BACKGROUND

### 1. Technical Field

The present disclosure relates to wireless communication, and more particularly, to a technique for efficient mobility management of a terminal.

### 2. Related Art

In a mobile communication system, a technology called handover can be utilized to ensure that users receive continuous communication services even while moving. The handover refers to a procedure performed to maintain continuity of a connection with a base station when a terminal moves from one base station to another.

However, in order for a terminal to perform handover, the terminal may need to transmit information related to the terminal to a network through higher layer signaling. As a result, it may take a significant amount of time for the terminal to transmit the terminal-related information to the network. Consequently, the terminal that transmits and receives large amounts of data may experience a reduction in a transmission rate due to a decrease in a signal to noise ratio (SNR) at a boundary of cells formed by different base stations. In addition, if the terminal's movement speed is very fast, a transmission delay caused by the handover may adversely affect delay-sensitive services.

To address the aforementioned issues, a conventional technique called soft handover has been proposed. The soft handover refers to a scheme in which a terminal switches its link between base stations while being simultaneously connected to both a current cell and a new cell. However, in the case of soft handover, since the terminal needs to transmit and receive signals through higher layer signaling to maintain its connection with a base station, it may take a significant amount of time, leading to excessive signaling overhead.

### SUMMARY

The present disclosure for resolving the above-described problems is directed to providing a method and an apparatus for performing efficient handover through rapid switching between radio links.

A method of a terminal, according to exemplary embodiments of the present disclosure for achieving the above-described objective, may comprise: receiving, from a first transmission and reception point (TRP) connected to the terminal, a message indicating terminal-based timing advance (TA) acquisition; receiving synchronization signal block(s) (SSB(s)) from one or more TRPs belonging to neighboring cell(s) according to the indication of the first TRP; determining a timing advance (TA) based on the SSB(s); transmitting information on the TA to the first TRP; receiving a cell switch command from the first TRP; and establishing a connection with a second TRP selected according to the cell switch command among the one or more TRPs belonging to the neighboring cell(s).

The message indicating terminal-based TA acquisition may be a medium access control (MAC) control element (CE).

The method may further comprise: before receiving the message indicating terminal-based TA acquisition, transmitting capability information of the terminal to the first TRP.

The capability information of the terminal may include at least one of information indicating whether the terminal performs a cross-correlation operation for the SSB(s) received from the one or more TRPs belonging to the neighboring cell(s) or a message indicating whether the terminal performs a timing difference update operation based on the TA.

The method may further comprise: after receiving the message indicating terminal-based TA acquisition, releasing a random access channel (RACH)-based TA acquisition scheme using a random access response (RAR)-less mode.

The TA may be determined by the terminal performing a cross-correlation operation for the SSB(s).

The cell switch command may include at least one of a MAC-CE index field, a cell identity (ID) field, a beam index field, a TA field, or a terminal-based TA measurement indication field.

A method of a first transmission and reception point (TRP), according to exemplary embodiments of the present disclosure for achieving the above-described objective, may comprise: receiving, from a terminal connected to the first TRP, capability information of the terminal; transmitting a message indicating terminal-based timing advance (TA) acquisition to the terminal; receiving a TA for one or more TRPs belonging to neighboring cell(s) of the terminal from the terminal; and transmitting, to the terminal, a cell switch command indicating the terminal to establish a connection with a second TRP belonging to the neighboring cell.

The message indicating terminal-based TA acquisition may be a medium access control (MAC) control element (CE).

The transmitting of the message indicating terminal-based TA acquisition to the terminal may be performed when the terminal is moving at a speed equal to or greater than a threshold or according to a request of the terminal, after the first TRP receives the capability information of the terminal.

The method may further comprise: determining a first TA by reflecting a downlink transmission timing difference in the TA after receiving the TA.

The cell switch command may include at least one of a medium access control (MAC)-control element (CE) index field, a cell identity (ID) field, a beam index field, a TA field, or a terminal-based TA measurement indication field.

The TA field may include information indicating a first TA obtained by reflecting a downlink transmission timing difference in the TA.

A terminal, according to exemplary embodiments of the present disclosure for achieving the above-described objective, may comprise at least one processor, and the at least one processor may cause the terminal to perform: receiving, from a first transmission and reception point (TRP) connected to the terminal, a message indicating terminal-based timing advance (TA) acquisition; receiving synchronization signal block(s) (SSB(s)) from one or more TRPs belonging to neighboring cell(s) according to the indication of the first TRP; determining a timing advance (TA) based on the SSB(s); transmitting information on the TA to the first TRP; receiving a cell switch command from the first TRP; and establishing a connection with a second TRP selected according to the cell switch command among the one or more TRPs belonging to the neighboring cell(s).

The message indicating terminal-based TA acquisition may be a medium access control (MAC) control element (CE).

The at least one processor may further cause the terminal to perform: before receiving the message indicating terminal-based TA acquisition, transmitting capability information of the terminal to the first TRP.

The capability information of the terminal may include at least one of information indicating whether the terminal performs a cross-correlation operation for the SSB(s) received from the one or more TRPs belonging to the neighboring cell(s) or a message indicating whether the terminal performs a timing difference update operation based on the TA.

The at least one processor may further cause the terminal to perform: after receiving the message indicating terminal-based TA acquisition, releasing a random access channel (RACH)-based TA acquisition scheme using a random access response (RAR)-less mode.

The TA may be determined by the terminal performing a cross-correlation operation for the SSB(s).

The cell switch command may include at least one of a MAC-CE index field, a cell identity (ID) field, a beam index field, a TA field, or a terminal-based TA measurement indication field.

According to the present disclosure, a TRP in a connected state with a terminal may transmit a physical downlink control channel (PDCCH) order to the terminal. The transmitted PDCCH order may include a field indicating a random access response (RAR)-less mode. The terminal may not receive an RAR message due to the field. In conventional schemes, it may take a significant amount of time for a terminal to receive an RAR message from a TRP in a connected state with the terminal. However, by applying the above-described method, such delay can be mitigated.

According to the present disclosure, when a terminal is moving at a very high speed, the terminal may receive a radio resource control (RRC) message including information indicating ‘terminal-based timing advance (TA) acquisition from a TRP currently connected to the terminal. Upon receiving the RRC message, the terminal may determine a TA based on a synchronization signal block (RRC) received from a neighboring TRP. At a very high speed, maintaining two links may cause issues with transmission rates and reliability. However, by determining the TA on its own, as described above, the terminal can resolve these issues, ensuing stable transmission rate and reliability even at the very high speed.

### BRIEF DESCRIPTION OF DRAWINGS

FIG. 1 is a conceptual diagram illustrating exemplary embodiments of a communication system.

FIG. 2 is a block diagram illustrating exemplary embodiments of an apparatus.

FIG. 3 is a conceptual diagram illustrating exemplary embodiments of TRPs performing communication with a moving terminal.

FIG. 4 is a conceptual diagram illustrating exemplary embodiments of TRPs performing communication with a moving terminal.

FIG. 5 is a sequence chart illustrating exemplary embodiments of a method for a terminal to perform a handover.

FIG. 6 is a sequence chart illustrating exemplary embodiments of a method for a terminal to perform a handover.

FIG. 7 is a sequence chart illustrating exemplary embodiments of a method for a terminal to perform a handover.

FIG. 8 is a sequence chart illustrating exemplary embodiments of a method for a terminal to perform a handover.

FIG. 9 is a sequence chart illustrating exemplary embodiments of a method for a terminal to perform a handover.

FIG. 10 is a sequence chart illustrating exemplary embodiments of a method for a terminal to perform a handover.

FIG. 11 is a sequence chart illustrating exemplary embodiments of a method for switching a TA determination scheme.

FIG. 12 is a sequence chart illustrating exemplary embodiments of a method for switching a TA determination scheme.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, the terminal may refer to various devices such as a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like that a user of mobile communication services can use.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Throughout the present disclosure, a non-terrestrial node may refer to a communication node mounted on a satellite. Throughout the present disclosure, a terrestrial node may refer to a communication node located on the ground. Throughout the present disclosure, a communication node may be used to encompass both a non-terrestrial node and a terrestrial node. Throughout the present disclosure, a cell may refer to a service area in which a mobile communication service is provided through a base station. Throughout the present disclosure, cell (re) selection may refer to cell selection by which a terminal selects a serving cell to receive a mobile communication service when initially accessing a mobile communication network, and/or cell re-selection by which a terminal selects a serving cell on which to camp.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

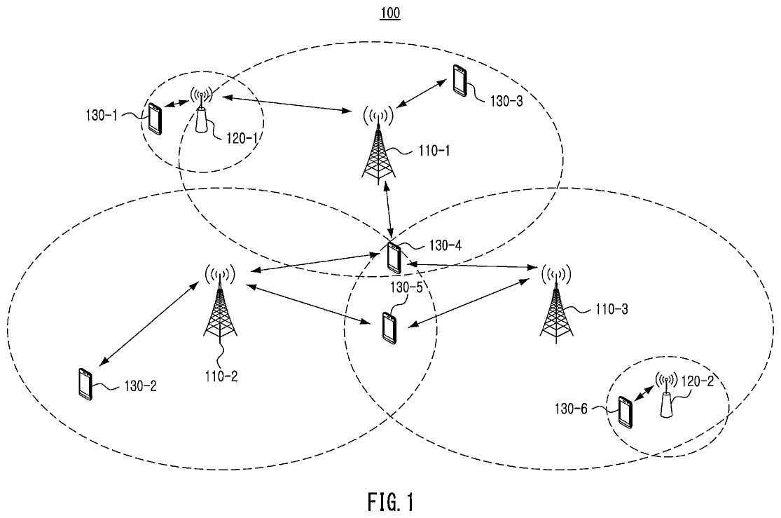

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further comprise a core network (e.g. a serving gateway (S-GW), a packet data network (PDN) gateway (P-GW), and a mobility management entity (MME)). When the communication system 100 is a 5G communication system (e.g. New Radio (NR) system), the core network may include an access and mobility management function (AMF), a user plane function (UPF), a session management function (SMF), and the like.

The plurality of communication nodes 110 to 130 may support communication protocols defined in the 3rd generation partnership project (3GPP) technical specifications (e.g. LTE communication protocol, LTE-A communication protocol, NR communication protocol, or the like). The plurality of communication nodes 110 to 130 may support code division multiple access (CDMA) technology, wideband CDMA (WCDMA) technology, time division multiple access (TDMA) technology, frequency division multiple access (FDMA) technology, orthogonal frequency division multiplexing (OFDM) technology, filtered OFDM technology, cyclic prefix OFDM (CP-OFDM) technology, discrete Fourier transform-spread-OFDM (DFT-s-OFDM) technology, orthogonal frequency division multiple access (OFDMA) technology, single carrier FDMA (SC-FDMA) technology, non-orthogonal multiple access (NOMA) technology, generalized frequency division multiplexing (GFDM) technology, filter band multi-carrier (FBMC) technology, universal filtered multi-carrier (UFMC) technology, space division multiple access (SDMA) technology, or the like. Each of the plurality of communication nodes may refer to an apparatus or a device. Exemplary embodiments may be performed by an apparatus or device. A structure of the apparatus (or, device) may be as follows.

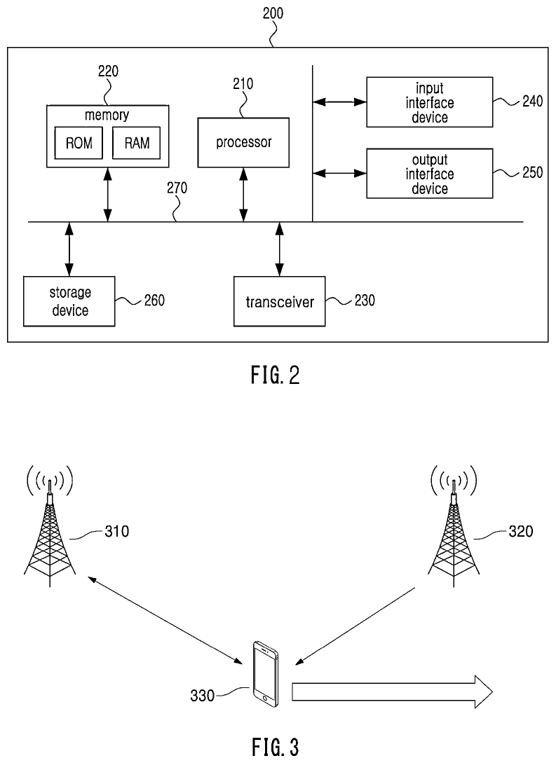

FIG. 2 is a block diagram illustrating exemplary embodiments of an apparatus.

Referring to FIG. 2, the apparatus 200 may comprise at least one processor 210, a memory 220, and a transceiver 230 connected to the network for performing communications. Also, the apparatus 200 may further comprise an input interface device 240, an output interface device 250, a storage device 260, and the like. Each component included in the apparatus 200 may communicate with each other as connected through a bus 270. However, each component included in the apparatus 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with exemplary embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Even when a method (e.g. transmission or reception of a signal) performed at a first communication node among communication nodes is described, a second communication node corresponding thereto may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

FIG. 3 is a conceptual diagram illustrating exemplary embodiments of TRPs performing communication with a moving terminal.

Referring to FIG. 3, as mobile communication technology develops, utilization of ultra-high frequency bands may increase. As the utilization of ultra-high frequency bands increases, multi-transmission reception points (multi-TRP) may be considered to increase transmission efficiency and reliability in a band where radio waves with small coverage and strong straightness belong. In a multi-TRP environment, a terminal may transmit and receive data to and from multiple TRPs simultaneously or sequentially in uplink or downlink. In the multi-TRP environment, the number of links that require switching may increase when the terminal moves at a high speed. The terminal that performs communication with multiple TRPs in a small coverage may experience a greater number of link switching. Such frequent link switching may harm transmission efficiency and reliability of the entire mobile communication system. However, the frequent link switching may be an unsolvable problem in an environment where communication with multiple TRPs is essential. Therefore, performing link switching faster than before may be a solution to the problem.

After establishing a connection with a first TRP 310 in an initial access stage, the terminal 330 may additionally establish a connection with a second TRP 320 located around the first TRP 310. The terminal 330 may receive services from the two TRPs. In this case, the terminal 330 may move to the right. As the terminal 330 moves to the right, the terminal 330 may move away from the first TRP 310. As the terminal 330 moves away from the first TRP 310, the terminal 330 may lose its connection with the first TRP 310.

In order for the terminal 330 to receive reliable services from two TRPs, the terminal 330 may need to establish a connection with another TRP other than the first and second TRPs 310 and 320 before its connection with the first TRP 310 is lost.

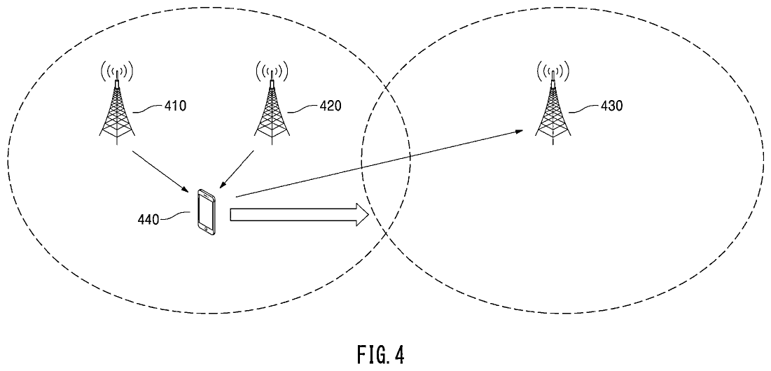

FIG. 4 is a conceptual diagram illustrating exemplary embodiments of TRPs performing communication with a moving terminal.

Referring to FIG. 4, a terminal 440 may be connected to first and second TRPs 410 and 420. The terminal 440 may move in a direction closer to a third TRP 430. As the terminal 440 moves in a direction closer to the third TRP 430, the terminal 440 may move away from the first TRP 410. As the terminal 440 moves away from the first TRP 410, the terminal may lose its connection with the first TRP 410. Therefore, the terminal 440 may need to establish a connection with the third TRP 430 before the connection with the first TRP 410 is lost.

The third TRP 430 may be a TRP belonging to a different cell from a cell to which the first and second TRPs 410 and 420 belong. Therefore, information broadcast by the third TRP 430 may be different information elements from information elements broadcast by the first and second TRPs 410 and 420 to the terminal. The broadcasted information may include a physical cell identity (PCI). Therefore, a PCI included in the information broadcast by the third TRP 430 may be different from the PCI included in the information broadcast by the first and second TRPs 410 and 420.

All exemplary embodiments described below may assume that the terminal and the TRPs are in the situation illustrated in FIG. 4. In each of exemplary embodiments below, if a reference numeral assigned to each communication node is the same as the reference numeral assigned to the communication node illustrated in FIG. 4, the each communication node may be the same communication node as the communication node illustrated in FIG. 4.

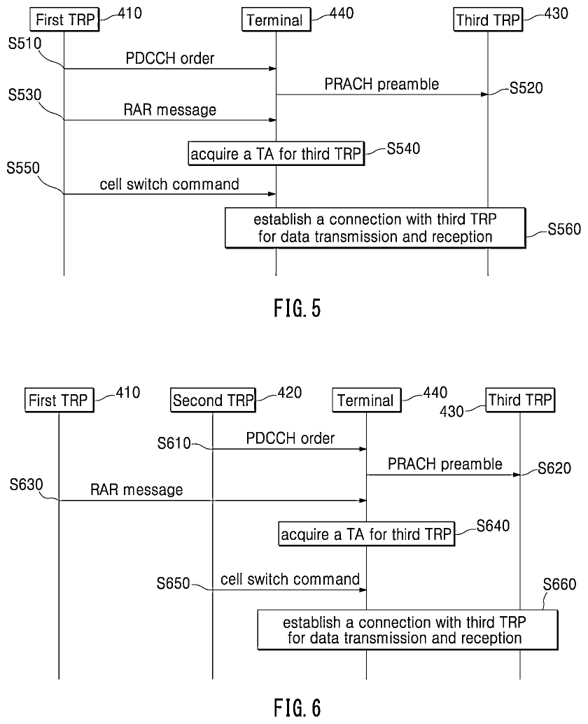

FIG. 5 is a sequence chart illustrating exemplary embodiments of a method for a terminal to perform a handover.

Referring to FIG. 5, the first TRP 410 may periodically receive neighboring cell search information from the terminal 440. Alternatively, the first TRP 410 may receive neighboring cell search information from the terminal 440 at a request of the first TRP 410. Based on the neighboring cell search information of the terminal 440, the first TRP 410 may identify a candidate cell (e.g. candidate TRP) with which the terminal 440 should establish a connection when the terminal 440 is disconnected from the first TRP 410.

The first TRP 410 may determine that the connection between the terminal 440 and the first TRP 410 is unstable and therefore connection switch is necessary. If the first TRP 410 determines that a connection switch is necessary, it may transmit a physical downlink control channel (PDCCH) order to the terminal 440 (S510). As an example, the PDCCH order may be transmitted to the terminal 440 as being included in a medium access control (MAC) control element (CE). The PDCCH-order may include at least one of a PCI, preamble index, or information on a PRACH occasion (RO) for the third TRP 430. The preamble may need to be transmitted through a pre-arranged location in the time and frequency domains so that the base station or the TRP can receive the preamble. Here, the ‘pre-arranged location in the time and frequency domain’ may mean the RO.

The terminal 440 may receive the PDCCH order from the first TRP 410 and transmit a physical random access channel (PRACH) preamble to the third TRP 430 based on the information included in the PDCCH order (S520). The third TRP 430 may receive the PRACH preamble from the terminal 440 and measure a timing advance (TA) based on the PRACH preamble. The measured TA may be informed to a third network (e.g. base station) connected to the third TRP 430.

The third network may receive information on the measured TA from the third TRP 430. The third network, which receives the TA measured by the third TRP 430, may transmit information on the measured TA to a first network connected to the first TRP 410. The first network connected to the first TRP 410 may transmit information on the TA to the first TRP 410. The first TRP 410 may receive information on the TA from the first network. The first TRP 410 may generate a random access response (RAR) message including the received TA. The first TRP 410 may transmit the generated RAR message to the terminal 440 (S530). The terminal 440 may receive the RAR message from the first TRP.

The terminal receives information on the TA from the first TRP 410 rather than directly from the third TRP for the following reason. If the terminal 440 receives information on the TA directly from the third TRP 430, consistency with the existing random access procedure may not be maintained. The method in which the terminal 440 receives information on the TA from the first TRP 410 may be inefficient. However, the method in which the terminal 440 receives information on the TA from the first TRP 410 may have the advantage of minimizing modifications to the existing 3GPP technical specifications.

Upon receiving information on the TA, the terminal 440 may obtain the TA for the third TRP 430 (S540). Unlike a higher layer-based handover, a lower layer-based handover can be performed quickly. The first TRP 410 may transmit a MAC CE including a cell switch command to the terminal 440 (S550). The terminal 440 may receive the MAC CE including the cell switch command from the first TRP 410. Alternatively, the first TRP 410 may maintain the existing link with the terminal 440 without transmitting the cell switch command to the terminal 440. However, if the first TRP 410 determines that the connection between the terminal 440 and the first TRP 410 may be lost, the first TRP 410 may transmit the cell switch command to the terminal 440, thereby switching the link between the first TRP 410 and the terminal 440.

The first TRP 410 may transmit the cell switch command to the terminal 440, thereby allowing the terminal 440 to establish a new connection with the third TRP 430. The terminal 440 may establish a connection with the third TRP 430 based on the TA for the third TRP 430 (S540).

FIG. 6 is a sequence chart illustrating exemplary embodiments of a method for a terminal to perform a handover.

Referring to FIG. 6, unlike the case of FIG. 5, the second TRP 420 may transmit a PDCCH order to the terminal 440 (S610). The transmitted PDCCH order may include at least one of a PCI, beam index, preamble index, and RO configuration information for the third TRP 430. The terminal 440 may receive the PDCCH order from the second TRP 420.

The terminal 440 receiving the PDCCH order may transmit a PRACH preamble to the third TRP 430 to obtain a TA for the third TRP 430 (S620). The third TRP 430 may receive the PRACH preamble from the terminal 440.

The third TRP 430 may receive the PRACH preamble from the terminal 440 and then measure a TA for a link between the terminal 440 and the third TRP 430 based on the PRACH preamble. The third TRP 430 may transmit information on the measured TA to the third network connected to the third TRP 430. The third network may receive information on the measured TA from the third TRP 430.

The first TRP 410 may support downlink control information (DCI) transmission in a Type 1 common search space (Type 1 CSS). The third network connected to the third TRP 430 may transmit information on the TA to the first TRP 410 supporting DCI transmission in the Type 1 CSS through the network connected to the first TRP 410.

The first TRP 410 may receive information on the TA from the first network connected to the first TRP 410. The first TRP 410 receiving information on the TA may generate an RAR message. The generated RAR message may include information on the TA. The first TRP 410 may transmit the generated RAR message to the terminal 440 (S630). The terminal 440 may receive the generated RAR message from the first TRP 410. The first TRP 410 rather than the second TRP 420 transmits the RAR message to the terminal 440 for the following reason.

A PDCCH may be transmitted in a CSS and/or a UE-specific search space (USS). A CSS may be used to transmit the RAR message. This may be because the RAR message is a response to the PRACH preamble and therefore needs to be received by all terminals. Therefore, only a TRP that supports DCI transmission (e.g. PDDCH transmission) in the CSS may transmit the RAR message.

The terminal 440 may receive the RAR message from the first TRP 410. The received RAR message may include information on the TA for the third TRP 430. Therefore, the terminal 440 may obtain the TA for the third TRP 430 after receiving the RAR message (S640).

When the terminal 440 obtain information on the TA for the third TRP 430, the terminal 440 may report the acquisition of the TA to the first TRP 410. The second TRP 420 may determine that the terminal 440 has acquired the TA based on the report of the terminal. In this case, the second TRP 420 may transmit a cell switch command to the terminal 440 (S650). The terminal 440 may receive the cell switch command from the second TRP 420. The cell switch command may include information instructing to release the connection between the terminal 440 and the first TRP 410. Upon receiving the cell switch command from the second TRP 420, the terminal 440 may release the connection with the first TRP 410 and establish a new connection with the third TRP 430 (S660). The release of the connection with the first TRP 410 may be performed through a higher layer.

After the terminal 440 performs link switching in the above-described manner, the terminal 440 can receive data and control signals from the second and third TRPs 420 and 430. However, control signals transmitted in the Type 1 CSS may still need to be received from the first TRP 410. This may be because the first TRP 410 supports the Type 1 CSS. The fact that the terminal 440 still receives control signals from the first TRP 410 even after disconnecting from the first TRP 410 may cause complex terminal operations. The complex terminal operations may lead to large power consumption of the terminal.

The terminal 440 may receive a control signal that is not transmitted in the Type 1 CSS from the TRP that transmits the PDCCH order. However, at the same time, the terminal 440 may receive information transmitted in the Type 1 CSS from a TRP other than the TRP that transmits the PDCCH order. Therefore, the number of links that the terminal 440 needs to manage may increase. The terminal 440 may continuously perform management so that connections with multiple links are maintained. If the TRP that supports DCI transmission in the Type 1 CSS is far away from the terminal, the terminal 440 may need to search for a TRP that supports DCI transmission in another Type 1 CSS. The above-described operations of the terminal may be very inefficient.

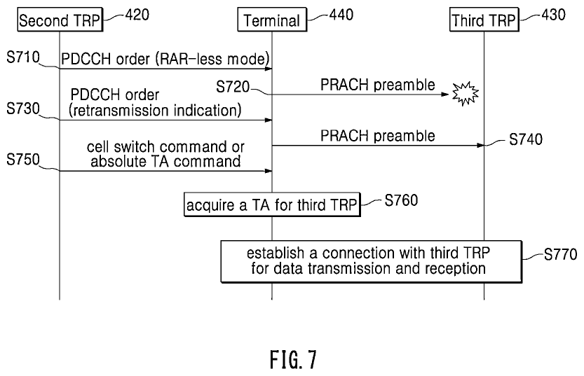

The existing RAR message may include various information in addition to information for TA acquisition. Therefore, if a purpose of the terminal 440 is only TA acquisition, the existing RAR message may be inefficient. It may take a long time for the terminal 440 to receive the RAR message after transmitting the PRACH preamble. To solve the above-described problems, a RAR-less solution may be proposed. A specific description on the RAR-less solution will be made with reference to FIG. 7.

FIG. 7 is a sequence chart illustrating exemplary embodiments of a method for a terminal to perform a handover.

Referring to FIG. 7, a RAR-less solution may be proposed. The RAR-less solution may be a scheme in which the terminal 440 does not receive the existing RAR message when performing TA acquisition for link switching. A method for allowing the terminal 440 not to receive the RAR message may be proposed as follows.

The second TRP 420 may transmit a PDCCH order to the terminal 440 so that the terminal 440 does not receive the RAR message (S710). The terminal 440 may receive the PDCCH order from the second TRP 420. The PDCCH order transmitted by the second TRP 420 to the terminal 440 may include a field indicating an RAR-less mode. The main fields included in the PDCCH order transmitted by the second TRP are as shown in Table 1 below.

TABLE 1

DCI index field
RAR mode filed (existing RAR/modified RAR/RAR-less)
Cell ID field
Beam index field
PRACH preamble index field
RACH occasion (RO) field
Retransmission indication field
TA field

The terminal 440 may receive the PDCCH order and determine that the RACH-less mode is enabled based on the information included in the PDCCH order. In other words, the terminal 440 may determine that a transmission and reception operation of an RAR message, which is a response to a PRACH preamble, is not performed. The terminal 440 receiving the PDCCH order may not receive an RAR message. By including the field indicating the RAR-less mode in the PDCCH order, the second TRP may not transmit a separate RRC message to the terminal 440 for configuring the RAR-less mode. Since the second TRP 420 does not transmit a separate RRC message to the terminal 440, signaling overhead may not occur. Alternatively, the second TRP 420 may configure the RAR-less mode to the terminal 440 in advance through RRC layer signaling.

The terminal 440 may receive the PDCCH order from the second TRP 420 (S710). Upon receiving the PDCCH order, the terminal 440 may transmit a PRACH preamble to the third TRP 430 (S720). However, the third TRP 430 may not receive the PRACH preamble. However, even if the terminal 440 transmits the PRACH preamble, the terminal 440 may not configure a response window for RAR message reception. Accordingly, even if the terminal 440 does not receive an RAR message, the terminal 440 may not retransmit the PRACH preamble to the third TRP 430. In the existing RAR mode, when the terminal 440 transmits the PRACH preamble, the terminal 440 may configure a response window. If the terminal 440 does not receive an RAR message within the response window, the terminal 440 may transmit the PRACH preamble to the TRP again.

If the terminal 440 does not configure a response window, a problem may occur in which the third TRP 430 does not properly receive the PRACH preamble. The second TRP 420 transmitting the PDCCH order may not receive information on a TA from the third TRP 430 even after a certain time elapses. If the second TRP 420 does not receive information on a TA from the third TRP 430 even after a certain time elapses, the second TRP 420 may determine that the transmission of the PRACH preamble to the third TRP 430 has not been performed smoothly. The second TRP 420 may transmit the PDCCH order to the terminal 440 again (S730). The transmitted PDCCH order may include a field indicating that the corresponding PDCCH order is the retransmitted PDCCH order.

The terminal 440 receiving the PDCCH order again may identify the field indicating that the corresponding PDCCH order is the retransmitted PDCCH order. The terminal 440 identifying the field may transmit the PRACH preamble to the third TRP 430 again (S740). When the terminal 440 transmits the PRACH preamble, the terminal 440 may need to increase a transmission power.

The third TRP 430 may receive the PRACH preamble retransmitted by the terminal 440. The third TRP 430 receiving the PRACH preamble may measure a TA. The measured TA may be informed to the third network connected to the third TRP 430. The third network connected to the third TRP 430 may transmit information on the measured TA to the second TRP 420 through a second network connected to the second TRP 420.

The second TRP 420 may receive information on the TA from the second network connected to the second TRP 420. The second TRP 420 may transmit a cell switch command including information on the received TA to the terminal 440 (S750). Alternatively, the second TRP 420 may transmit an absolute TA command including the TA to the terminal 440. The terminal 440 may receive the cell switch command and/or the absolute TA command including the TA from the second TRP 420.

Both the cell switch command and the absolute TA command described above may include a field and/or a cell ID indicating a TRP associated with the TA included in the corresponding command. This is because the terminal 440 cannot know whether the received cell switch command and/or absolute TA command is a response to the PRACH preamble that the terminal 440 previously transmitted to the third TRP 430 or a TA update command for the second TRP 420. One bit may be allocated to the field indicating the TRP associated with the TA included in the corresponding command. The fields included in the cell switch command and/or the absolute TA command may be expressed as shown in Table 2 below.

TABLE 2

MAC-CE index field
Cell ID or indication field
TA field

The terminal 440 may receive the cell switch command or absolute TA command. The terminal 440 receiving the cell switch command or absolute TA command may obtain the TA for the third TRP 430 by identifying the TA included in the cell switch command or absolute TA command (S760). The terminal 440 acquiring the TA for the third TRP 430 may release the connection between the terminal and the TRP (not shown) that was previously connected with the terminal 440. The terminal 440, which has released the connection between the terminal 440 and the TRP (not shown) that was previously connected, may establish a new connection with the third TRP 430 (S770).

The second TRP 420 may configure the third TRP 430 as a TRP for transmitting/receiving data and control signals with the terminal 440 through RRC signaling. The second TRP 420 may cause the TRP that was previously connected to the terminal 440 to release the connection with the terminal 440 through RRC signaling.

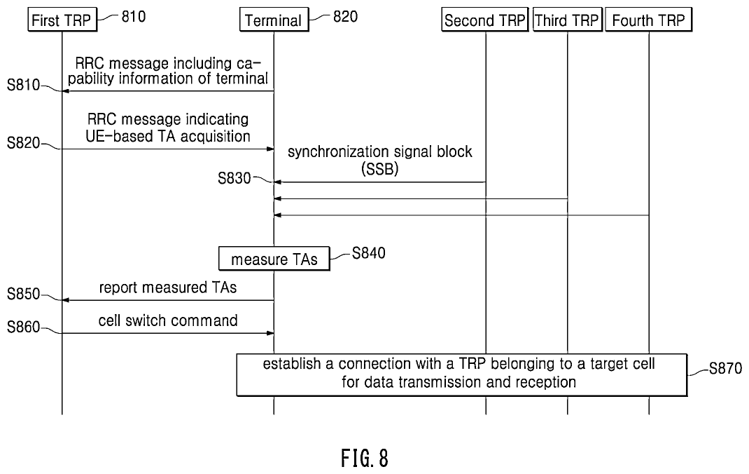

There may also be a problem with the RAR-less solution described above. According to the RAR-less solution, a TRP may transmit a PDCCH order to the terminal 440, and the terminal 440 receiving the PDCCH order may transmit a PRACH preamble to another TRP. Thereafter, the terminal 440 may receive a message including information on a TA from the TRP and then acquire the TA. The above-described series of operations may have a negative impact on a transmission rate and reliability of the terminal 440 moving at a very high speed. This may be because the terminal 440 needs to maintain two links while moving at a high speed. Therefore, a method for quickly acquiring the TA even when the terminal 440 moves at a high speed may be required. As a method for quickly acquiring the TA when the terminal 440 moves at a high speed, a ‘terminal (UE)-based TA acquisition’ method will be proposed with reference to FIG. 8.

FIG. 8 is a sequence chart illustrating exemplary embodiments of a method for a terminal to perform a handover.

Referring to FIG. 8, a UE-based TA acquisition procedure, which is one of methods for a terminal 820 to perform a handover, may be initiated. In general, the terminal 820 may report information on a channel to which a link to which the terminal 820 is currently connected (hereinafter, ‘current channel’) belongs to a TRP periodically or upon a request of the TRP. The information on the current channel may include a reference signal received power (RSRP), channel quality indicator (CQI), etc. The terminal 820 may report information on a link (e.g. neighboring channel) provided by a cell (hereinafter, ‘neighboring cell’) existing around a cell to which the terminal 820 currently belongs, to the TRP periodically or upon a request of the TRP. The information on the neighboring channel may include an RSRP. A reason why the terminal 820 transmits information on the neighboring channel as well as information on the current channel to the TRP may be that the terminal 820 can quickly switch to another link when an error occurs in the link that the terminal 820 is currently connected to.

The UE-based TA acquisition (measurement) scheme may be a scheme that allows the terminal 820 to measure a timing difference from a reference cell in addition to the signal strength during the process of searching for neighboring cells. The timing difference measured by the terminal 820 may refer to a TA measured by the terminal 820. In order for the terminal 820 to measure the timing difference, the terminal 820 may perform cross-correlation on an SSB transmitted from the neighboring cell to the terminal 820. By performing cross-correlation, the terminal 820 may need to find a time point at which the maximum peak occurs. Accordingly, performing cross-correlation by the terminal 820 may cause more power consumption than measuring the signal strength by the terminal 820.

The UE-based TA measurement scheme may have limitations due to the operations of the terminal 820 described above. This is because the number of times the terminal 820 can perform cross-correlation on SSBs received from neighboring cells and the terminal's ability to manage cross-correlation and update timing differences may vary depending on capability of the terminal 820. Therefore, the TRP may need to know UE-based TA measurement capability of each terminal 820 in advance. The TRP may cause the terminal 820 to perform UE TA measurement based on the UE-based TA measurement capability of the terminals 820 that the TRP knows in advance.

The terminal 820 may transmit an RRC message including information indicating the capability (UE capability) of the terminal 820 to the first TRP 810 at the initial access stage with the first TRP 810 or in the connected state with the first TRP 810 (S810). The first TRP 810 receiving the RRC message including information indicating the capability of the terminal may initiate a UE-based TA acquisition procedure if the first TRP 810 determines that the terminal 820 is moving at a high speed or if there is a request from the terminal 820.

The first TRP 810 may transmit an RRC message including information indicating UE-based TA acquisition to the terminal 820 (S820). All messages indicating the UE-based TA acquisition scheme of the terminal 820 below may also be transmitted through a MAC-CE. The terminal 820 may receive the RRC message including information indicating UE-based TA acquisition from the first TRP 810. The terminal 820 may receive the indication regarding UE-based TA acquisition from the first TRP 810. The terminal 820 may receive SSBs from TRPs (e.g. second, third, and fourth TRPs) existing in neighboring cells at each indicated period (S830). The terminal 820 may measure a timing difference for each TRP by performing cross-correlation on the received SSB (S840). The terminal 820 may update the timing difference for each TRP with the measured timing difference for each TRP. The number of timing differences to be measured by the terminal 820 may be determined according to the indication of the first TRP 810.

If the first TRP 810 requests the terminal 820 to report the measured TAs, the terminal 820 may transmit information on the measured TAs to the first TRP 810 (S850). The first TRP 810 receiving information on the TAs from the terminal 820 may determine that a link switch is necessary. If the first TRP 810 determines that a link switch is necessary, the first TRP 810 may select one of the neighboring cells reported by the terminal 820 (hereinafter referred to as a ‘target cell’).

The first TRP 810 that selects the target cell may transmit a cell switch command to the terminal 820 (S860). The terminal 820 may receive the cell switch command from the first TRP 810. The terminal 820 may receive an indication regarding switching to a link provided by the target cell by receiving the cell switch command of the first TRP 810. The terminal receiving the indication regarding switching to the link provided by the target cell may establish a new connection with a TRP belonging to the target cell (or a TRP forming the target cell) (S870). The above-described cell switch command may include at least one of a cell ID, a beam index, and a TA. The cell ID and the beam index may be a cell ID and a beam index of the target cell. The TA may be a TA for the TRP belonging to the target cell. The cell switch command used in the UE-based TA measurement procedure may include fields as shown in Table 3 below.

TABLE 3

MAC-CE index field
Cell ID field
Beam index field
TA field
UE-based TA measurement indication field

The TA informed by the first TRP 810 to the terminal 820 may be the same as or different from a TA measured by the terminal 820 itself. A reason why the TA informed by the first TRP 810 to the terminal 820 and the TA measured by the terminal 820 itself are different may be that there is a downlink transmission timing difference between neighboring cells. Assuming a non-ideal backhaul, the downlink transmission timing difference may occur because a time synchronization between the cell to which the terminal 820 is currently connected and the target cell does not match.

If the first TRP 810 transmits information indicating the downlink transmission timing difference to the terminal 820, the TA measured by the terminal 820 itself may be trusted. Therefore, if the terminal 820 receives information indicating the downlink transmission timing difference from the first TRP 810, the procedure for the terminal 820 to report the TA to the first TRP 810 may not be necessary. However, if the terminal 820 does not receive information indicating the downlink transmission timing difference from the first TRP 810, the TA measured by the terminal 820 may not be trusted, so the procedure for reporting the TA measured by the terminal 820 to the first TRP 810 may be necessary. The first TRP 810 may generate a TA to be actually used by the terminal 820 by reflecting the downlink transmission timing difference in the TA received from the terminal 820. The generated TA may be informed to the terminal 820. The terminal 820 receiving information on the generated TA may perform uplink communication with the target cell using the TA generated by the first TRP 810.

If the cell switch command that the first TRP 810 transmits to the terminal 820 does not include the TA field, it may imply that the terminal 820 uses the TA measured by the terminal 820 itself.

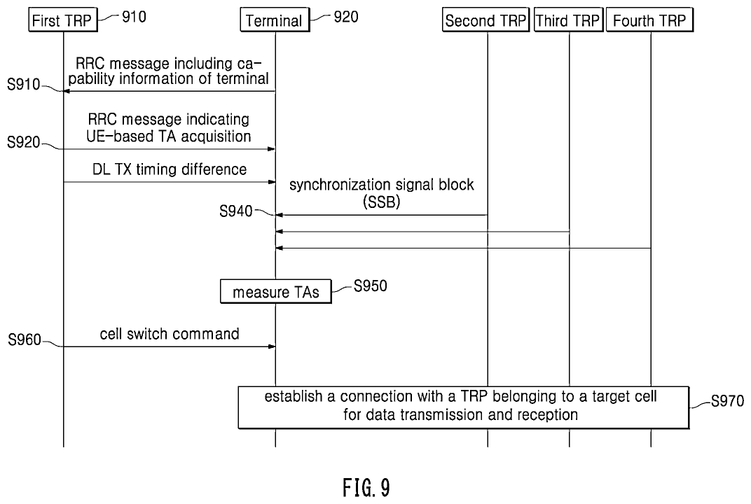

FIG. 9 is a sequence chart illustrating exemplary embodiments of a method for a terminal to perform a handover.

Referring to FIG. 9, a terminal 920 may transmit an RRC message including capability of the terminal 920 to a first TRP 910 (S910). The first TRP 910 receiving the RRC message including the capability of the terminal 920 may transmit an RRC message including information indicating UE=based TA acquisition to the terminal 920 (S920). The message indicating the UE-based TA acquisition to the terminal 920 may also be transmitted through a MAC-CE or RRC message. The first TRP 910 may transmit information elements indicating downlink transmission timing difference(s) for neighboring cell(s) to the terminal 920 (S930).

The terminal 920 receiving the RRC message including information indicating UE-based TA measurement from the first TRP 910 may receive SSBs from TRPs (e.g. second, third, and fourth TRPs) included in neighboring cells (S940). The terminal 920 may measure TAs on its own by performing cross-correlation on the received SSBs (S950). Since the terminal 920 receives the information elements indicating the downlink transmission timing difference(s) for neighboring cell(s) from the first TRP 910, the terminal 920 may not perform a procedure for reporting the TAs measured by the terminal to the first TRP 910.

The first TRP 910 may transmit a cell switch command to the terminal 920 (S960). The cell switch command transmitted by the first TRP 910 may not include information indicating a TA. The terminal 920 may receive the cell switch command from the first TRP 910. The terminal 920 receiving the cell switch command may establish a connection for data transmission and reception with a TRP belonging to a target cell (S970).

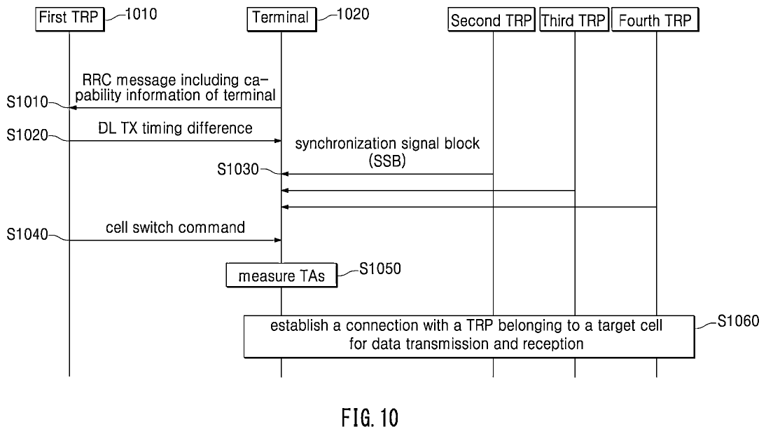

FIG. 10 is a sequence chart illustrating exemplary embodiments of a method for a terminal to perform a handover.

Referring to FIG. 10, a terminal 1020 may transmit an RRC message including capability of the terminal 1020 to a first TRP 1010 (S1010). The first TRP 1010 receiving the RRC message including the capability of the terminal 1020 from the terminal 1020 may transmit information elements indicating downlink transmission timing difference(s) for neighboring cell(s) to the terminal 1020 (S1020).

The terminal 1020 receiving the information elements indicating the downlink transmission timing difference for neighboring cells may receive SSBs from TRPs (e.g. second TRP, third TRP, fourth TRP) included in the neighboring cells (S1030). The terminal 1020 receiving the SSBs may not immediately perform a procedure for acquiring TAs by performing cross-correlation for the SSBs. This may be because a lot of power may be consumed in the procedure for the terminal 1020 to obtain TAs for the neighboring cells.

The first TRP 1010 may transmit a cell switch command to the terminal 1020 (S1040). The transmitted cell switch command may include information elements indicating a cell ID, a beam index, and UE-based TA measurement. The terminal 1020 receiving the cell switch command from the first TRP 1010 may then perform a procedure for measuring TAs for the neighboring cells (S1050). The terminal 1020 may establish a new connection with a TRP belonging to a target cell using the measured TA (S1060).

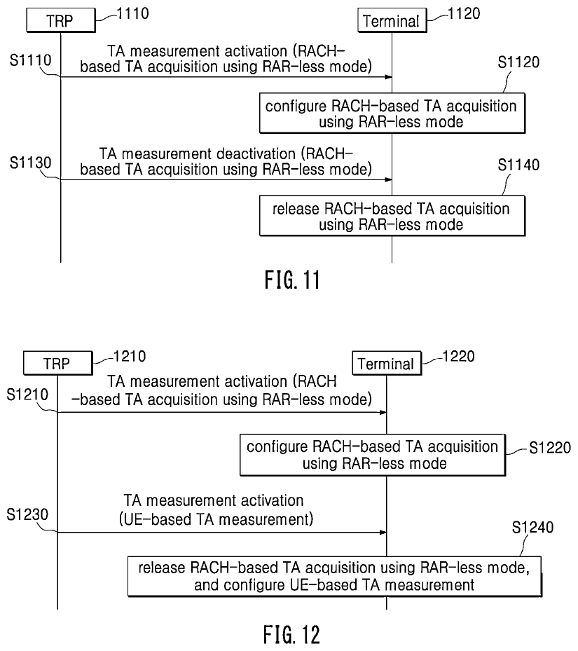

As described above, the present disclosure proposed the terminal-based (i.e. UE-based) TA measurement scheme and the RACH-based TA acquisition scheme. The RACH-based TA acquisition method may be classified into the RAR-based scheme and the RAR-less scheme. It may not be efficient if only one of the three schemes described above is used. When the terminal 1020 is moving at a medium speed, the RACH-based TA acquisition scheme may be useful. When the terminal 1020 is moving at a very high speed, the UE-based TA measurement scheme may be useful. When the terminal 1020 performs a handover, it may be necessary to apply all three schemes according to a moving speed of the terminal 1020. Therefore, a method may be required to flexibly select and use one of the three scheme according to a need. A method of flexibly selecting and using one of the three schemes will be described with reference to FIGS. 11 and 12.

FIG. 11 is a sequence chart illustrating exemplary embodiments of a method for switching a TA determination scheme.

Referring to FIG. 11, a TRP 1110 may select one of various TA measurement schemes in consideration of a moving speed of a terminal 1120. The selected TA measurement scheme may be informed to the terminal 1120 by the TRP 1110. For example, when the terminal 1120 is moving at a medium speed, the RACH-based TA acquisition scheme may be useful. When the terminal 1120 is moving at a very high speed, the UE-based TA measurement scheme may be useful.

The TRP 1110 may transmit a MAC CE indicating the terminal 1120 to activate TA measurement (S1110). The transmitted MAC CE may include a field indicating the RACH-based TA acquisition scheme using the RAR-less mode. The terminal 1120 receiving the MAC CE may configure its TA acquisition scheme to the RACH-based TA acquisition scheme using the RAR-less mode (S1120).

The TRP 1110 may transmit a MAC CE indicating the terminal 1120 to deactivate TA measurement (S1130). The transmitted MAC CE may include a field indicating the RACH-based TA acquisition scheme using the RAR-less mode. The terminal 1120 receiving the MAC CE may deactivate the RACH-based TA acquisition scheme using the RAR-less mode (S1140).

The MAC CE transmitted by the TRP 1110 to the terminal 1120 may include fields as shown in Table 4 below.

TABLE 4
MAC-CE index field
Activation/deactivation
UE-based TA measurement/RACH-based TA acquisition using RAR-
less mode/RACH-based TA acquisition using RAR

FIG. 12 is a sequence chart illustrating exemplary embodiments of a method for switching a TA determination scheme.

Referring to FIG. 12, a TRP 1210 may transmit a MAC CE indicating a terminal 1220 to activate TA measurement (S1210). The transmitted MAC CE may include a field indicating the RACH-based TA acquisition scheme using the RAR-less mode. The terminal 1220 receiving the MAC CE may configure its TA acquisition scheme to the RACH-based TA acquisition scheme using the RAR-less mode (S1220).

The TRP 1210 may transmit a MAC CE indicating the terminal 1220 to activate TA measurement (S1230). The transmitted MAC CE may include a field indicating the UE-based TA measurement scheme. The terminal 1220 receiving the MAC CE may activate the UE-based TA measurement scheme after deactivating the RACH-based TA acquisition scheme using the RAR-less mode (S1240).

As described above, the TRP 1210 may transmit a MAC CE indicating the terminal 1220 to activate the TA measurement scheme without transmitting a MAC CE indicating the terminal 1220 to deactivate the previous TA measurement scheme, in order to allow the terminal 1220 to automatically deactivate the TA measurement scheme that the terminal 1220 previously uses.

Some aspects of the present disclosure have been described in the context of a device, but it should be understood that the corresponding methods can also be described, where blocks or devices correspond to method steps or characteristics of method steps. Similarly, aspects described in the context of a method can also be represented as corresponding blocks or items or as characteristics of corresponding devices. Some or all of the method steps may be performed (or implemented) by hardware devices, such as a microprocessor, a programmable computer, or electronic circuits. In some exemplary embodiments, at least one of the most important method steps can be performed by such devices.

In some exemplary embodiments, a programmable logic device (e.g. a field-programmable gate array) can be used to perform some or all of the functions of the methods described herein. In some exemplary embodiments, the field-programmable gate array can operate in conjunction with a microprocessor to perform one of the methods described herein. In general, it is preferable for the methods to be performed by some hardware device.

While the preferred exemplary embodiments of the present disclosure have been described above, it will be understood by those skilled in the art that the present disclosure can be variously modified and changed without departing from the spirit and scope of the present disclosure as set forth in the following claims.

What is claimed is:

1. A method of a terminal, comprising:
receiving, from a first transmission and reception point (TRP) connected to the terminal, a message indicating terminal-based timing advance (TA) acquisition;
receiving synchronization signal block(s) (SSB(s)) from one or more TRPs belonging to neighboring cell(s) according to the indication of the first TRP;
determining a timing advance (TA) based on the SSB(s);
transmitting information on the TA to the first TRP;
receiving a cell switch command from the first TRP; and
establishing a connection with a second TRP selected according to the cell switch command among the one or more TRPs belonging to the neighboring cell(s).

2. The method according to claim 1, wherein the message indicating terminal-based TA acquisition is a medium access control (MAC) control element (CE).

3. The method according to claim 1, further comprising: before receiving the message indicating terminal-based TA acquisition, transmitting capability information of the terminal to the first TRP.

4. The method according to claim 3, wherein the capability information of the terminal includes at least one of information indicating whether the terminal performs a cross-correlation operation for the SSB(s) received from the one or more TRPs belonging to the neighboring cell(s) or a message indicating whether the terminal performs a timing difference update operation based on the TA.

5. The method according to claim 1, further comprising: after receiving the message indicating terminal-based TA acquisition, releasing a random access channel (RACH)-based TA acquisition scheme using a random access response (RAR)-less mode.

6. The method according to claim 1, wherein the TA is determined by the terminal performing a cross-correlation operation for the SSB(s).

7. The method according to claim 1, wherein the cell switch command includes at least one of a MAC-CE index field, a cell identity (ID) field, a beam index field, a TA field, or a terminal-based TA measurement indication field.

8. A method of a first transmission and reception point (TRP), comprising:
receiving, from a terminal connected to the first TRP, capability information of the terminal;
transmitting a message indicating terminal-based timing advance (TA) acquisition to the terminal;
receiving a TA for one or more TRPs belonging to neighboring cell(s) of the terminal from the terminal; and
transmitting, to the terminal, a cell switch command indicating the terminal to establish a connection with a second TRP belonging to the neighboring cell.

9. The method according to claim 8, wherein the message indicating terminal-based TA acquisition is a medium access control (MAC) control element (CE).

10. The method according to claim 8, wherein the transmitting of the message indicating terminal-based TA acquisition to the terminal is performed when the terminal is moving at a speed equal to or greater than a threshold or according to a request of the terminal, after the first TRP receives the capability information of the terminal.

11. The method according to claim 8, further comprising: determining a first TA by reflecting a downlink transmission timing difference in the TA after receiving the TA.

12. The method according to claim 8, wherein the cell switch command includes at least one of a medium access control (MAC)-control element (CE) index field, a cell identity (ID) field, a beam index field, a TA field, or a terminal-based TA measurement indication field.

13. The method according to claim 12, wherein the TA field includes information indicating a first TA obtained by reflecting a downlink transmission timing difference in the TA.

14. A terminal comprising at least one processor, wherein the at least one processor causes the terminal to perform:
receiving, from a first transmission and reception point (TRP) connected to the terminal, a message indicating terminal-based timing advance (TA) acquisition;
receiving synchronization signal block(s) (SSB(s)) from one or more TRPs belonging to neighboring cell(s) according to the indication of the first TRP;
determining a timing advance (TA) based on the SSB(s);
transmitting information on the TA to the first TRP;
receiving a cell switch command from the first TRP; and
establishing a connection with a second TRP selected according to the cell switch command among the one or more TRPs belonging to the neighboring cell(s).

15. The terminal according to claim 14, wherein the message indicating terminal-based TA acquisition is a medium access control (MAC) control element (CE).

16. The terminal according to claim 14, wherein the at least one processor further causes the terminal to perform: before receiving the message indicating terminal-based TA acquisition, transmitting capability information of the terminal to the first TRP.

17. The terminal according to claim 14, wherein the capability information of the terminal includes at least one of information indicating whether the terminal performs a cross-correlation operation for the SSB(s) received from the one or more TRPs belonging to the neighboring cell(s) or a message indicating whether the terminal performs a timing difference update operation based on the TA.

18. The terminal according to claim 14, wherein the at least one processor further causes the terminal to perform: after receiving the message indicating terminal-based TA acquisition, releasing a random access channel (RACH)-based TA acquisition scheme using a random access response (RAR)-less mode.

19. The terminal according to claim 14, wherein the TA is determined by the terminal performing a cross-correlation operation for the SSB(s).

20. The terminal according to claim 14, wherein the cell switch command includes at least one of a MAC-CE index field, a cell identity (ID) field, a beam index field, a TA field, or a terminal-based TA measurement indication field.
